(19) United States
(12) Patent Application Publication
(10) Pub. No.: US 2010/0209744 A1
(43) Pub. Date: Aug. 19, 2010

(54) BATTERY PACK AND MOBILE COMMUNICATION TERMINAL

(75) Inventor: Bongyoung KIM, Suwon-si (KR)

Correspondence Address: STEIN MCEWEN, LLP, 1400 EYE STREET, NW, SUITE 300, WASHINGTON, DC, 20005, US

(73) Assignee: Samsung SDI Co., Ltd., Suwon-si (KR)

(21) Appl. No.: 12/706,217

(22) Filed: Feb. 16, 2010

(30) Foreign Application Priority Data
Feb. 18, 2009 (KR) 10-2009-0013488

(51) Int. Cl. H01M 2/16; H01M 14/00

(52) U.S. Cl. 429/8; 429/247

(57) ABSTRACT

A battery pack including a bare cell and an absorber disposed on a surface of the bare cell. The absorber is formed of a ferrite sintered body, which may be divided into sections.

### CROSS-REFERENCE TO RELATED APPLICATION

This application claims the benefit of Korean Patent Application No. 10-2009-0013488, filed on Feb. 18, 2009, in the Korean Intellectual Property Office, the disclosure of which is incorporated herein, by reference.

### BACKGROUND OF THE INVENTION

1. Field of the Invention

Aspects of the present invention relate to a battery pack and a mobile communication terminal including the same.

2. Description of the Related Art

A mobile communication terminal can perform data communication with a reader (or a base station) located near the terminal, through radio-frequency (RF) signal transmission/reception. The development of the radio frequency identification (RFID) technology using RF signals enables various additional applications, such as the use of transit fare payment cards and electronic transactions.

Such RF signal transmission/reception between a mobile terminal and a reader can be performed through an antenna installed in the terminal, or in a battery pack disposed in the terminal. In order to facilitate communication between an antenna and a reader, it is desirable to eliminate noise and to improve RF sensitivity.

### SUMMARY OF THE INVENTION

Aspects of the present invention provide a battery pack capable of enhancing RF sensitivity, thus ensuring improved communication between a mobile terminal including the battery pack, and an external electronic apparatus.

According to an aspect of the present invention, there is provided a battery pack including: a bare cell; and an absorber disposed on a large lateral surface of the bare cell, which is formed of a ferrite sintered body.

According to aspects of the present invention, the ferrite may be selected from the group consisting of nickel ferrite, zinc ferrite, nickel-zinc ferrite, and barium ferrite. The nickel-zinc ferrite may be composed of from about 47 to 48 wt % of iron oxide, 30 wt % of nickel oxide, 20 wt % of zinc oxide, and from 2 to 3 wt % of copper oxide, based on the total weight of the ferrite. The absorber may have magnetic permeability of from about 100 to 115 T.

According to aspects of the present invention, the absorber may have a thickness of 1 mm, or less, for example, from about 0.05 to 0.3 mm. The absorber may cover between about 50% and 100% of the large lateral surface of the bare cell.

According to aspects of the present invention, the battery pack may include a polymer layer covering the absorber, in order to compensate for the fragility of the ferrite. The absorber may be attached to the bare cell by a double-sided tape or an adhesive.

According to aspects of the present invention, the absorber may be disposed in a corresponding groove formed on the large lateral surface of the bare cell.

According to aspects of the present invention, the ferrite sintered body may include a plurality of individual sections. The sections may be triangular or rectangular.

According to aspects of the present invention, a loop antenna may be disposed on a large lateral surface of the absorber, and may be electrically connected to a protection circuit module. The loop antenna may transmit and/or receive a 13.56 MHz RF signal.

According to aspects of the present invention, the loop antenna may include a loop-shaped antenna pattern and a coverlay film covering the antenna pattern. The loop antenna may include an insulator surrounding the antenna pattern, instead of the coverlay film. The antenna pattern may be made of copper.

According to aspects of the present invention, the battery pack may be employed in a mobile communication terminal.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the exemplary embodiments taken in conjunction with the accompanying drawings, of which:

FIG. 1 is a perspective view of a battery pack, according to an exemplary embodiment of the present invention;

FIG. 2 is an exploded perspective view of a battery pack, according to an exemplary embodiment of the present invention;

FIGS. 3 and 4 are respectively 500× and 2000× scanning electron microscopic (SEM) images of an absorber, according to an exemplary embodiment of the present invention;

FIG. 5 is a perspective view of a protection circuit module, according to an exemplary embodiment of the present invention;

FIG. 6 is a perspective view of a battery pack, according to an exemplary embodiment of the present invention wherein a case and a label are omitted;

FIG. 7 is an exploded perspective view of a battery pack, according to another exemplary embodiment of the present invention;

FIGS. 8 and 9 are plan views of absorbers, according to other exemplary embodiments of the present invention; and

FIG. 10 is a perspective view of a loop antenna, according to another exemplary embodiment of the present invention.

### DETAILED DESCRIPTION OF THE EXEMPLARY EMBODIMENTS

Reference will now be made in detail to the exemplary embodiments of the present invention, examples of which are illustrated in the accompanying drawings, wherein like reference numerals refer to like elements throughout. The exemplary embodiments are described below, in order to explain the aspects of the present invention, by referring to the figures.

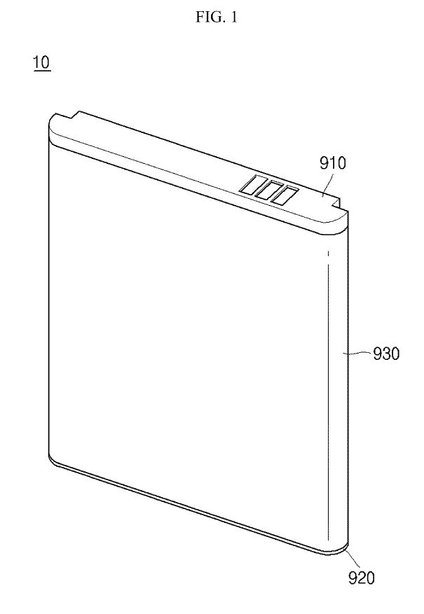

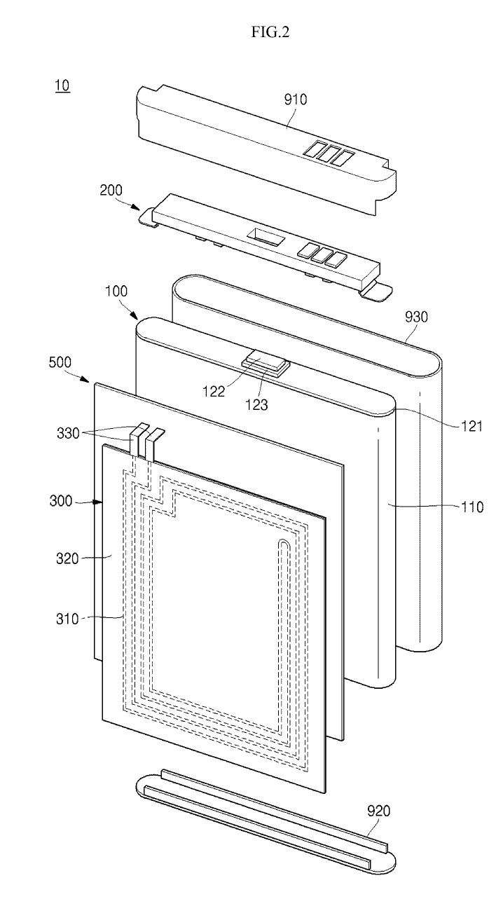

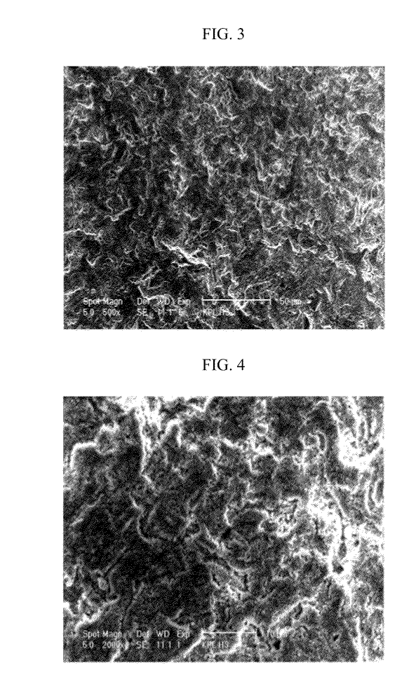

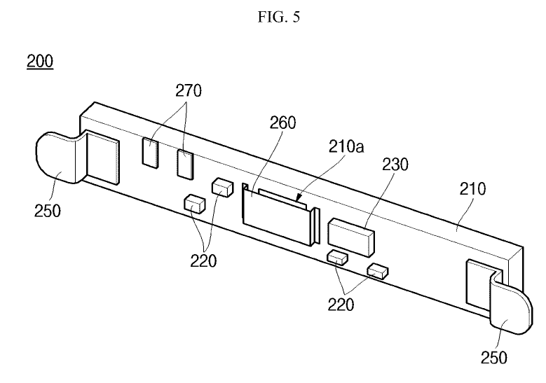

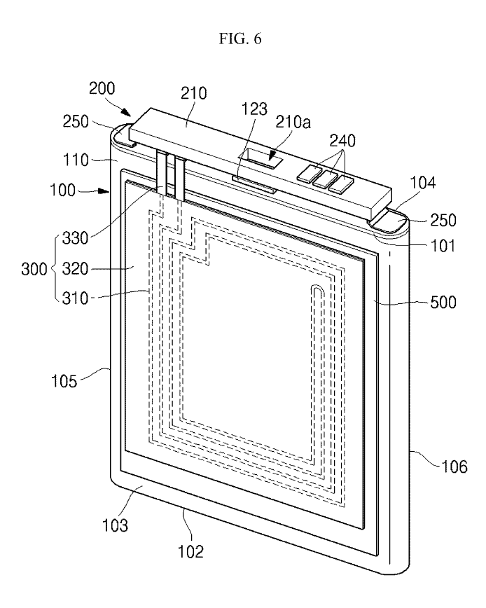

FIGS. 1 and 2 are respectively a perspective view and an exploded perspective view of a battery pack 10, according to an exemplary embodiment of the present invention. FIGS. 3 and 4 are respectively 500× and 2000× scanning electron microscopic (SEM) images of an absorber 500, according to an exemplary embodiment of the present invention. FIG. 5 is a perspective view of a protection circuit module 200, according to an exemplary embodiment of the present invention, and FIG. 6 is a perspective view of the battery pack 10, wherein a case and a label are omitted.

Referring to FIGS. 1 through 6, the battery pack 10 includes a bare cell 100, the protection circuit module 200, a loop antenna 300, the absorber 500, an upper case 910, a lower case 920, and a label 930. The absorber 500 is a ferrite sintered body having a high magnetic permeability. The absorber 500 is capable of improving the RF sensitivity of the loop antenna 300, leading to improved communication between an external reader and the battery pack 10.

The bare cell 100 may include: a can 110; an electrode assembly (not shown) disposed in the can; and a cap assembly to seal the can 110. The bare cell 100 is a minimum charging/discharging unit of the battery pack 10, and includes a positive electrode and a negative electrode.

The can 110 may be formed in a generally rectangular parallelepiped shape. An opening may be formed in a surface of the can 110 (e.g., the top surface in FIG. 2) other surfaces thereof (e.g., lateral surfaces in FIG. 2) may be curved. The can 110 may be made of a light-weight metal material such as aluminum (Al), and may serve as a positive terminal.

The electrode assembly may include a positive electrode plate, a negative electrode plate, and a separator interposed therebetween. The electrode assembly may be formed by winding the positive electrode plate, the negative electrode plate, and the separator into a jellyroll-type structure. The electrode assembly may be inserted into the can 110, via the opening, which is sealed by the cap assembly.

The cap assembly includes a cap plate 121, an electrode terminal 122, a gasket 123, an insulating plate (not shown), and a terminal plate (not shown). The cap assembly may be combined with the electrode assembly, along with an insulating case (not shown), to seal the opening of the can 110. The electrode terminal 122 may serve as a negative terminal.

The exterior of the bare cell 100 may include a top surface 101 on which the electrode terminal 122 is installed, a opposing bottom surface 102, a pair of large lateral surfaces 103 and 104, and a pair of small lateral surfaces 105 and 106. Here, the large lateral surfaces 103 and 104 have a larger surface area than the small lateral surfaces 105 and 106.

The protection circuit module 200 may be disposed on a surface (e.g., the top surface in FIG. 6) of the bare cell 100 and electrically connected to the bare cell 100. The protection circuit module 200 may include a protection circuit board 210, a protection circuit device 220, an integrated circuit (IC) chip 230, a charge-discharge terminal 240, a positive electrode lead plate 250, a negative electrode lead plate 260, and a loop antenna terminal 270. A positive temperature coefficient (PTC) device (not shown) may be further disposed on the bottom surface of the protection circuit board 210.

The protection circuit board 210 may be disposed adjacent to a surface of the bare cell 100 (e.g., the top surface in FIG. 6) and may be rectangular. Conductive metal patterns (not shown) may be formed in the protection circuit board 210 and may be electrically connected to the protection circuit device 220, the IC chip 230, the charge-discharge terminal 240, the positive electrode lead plate 250, the negative electrode lead plate 260, and the loop antenna terminal 270.

The protection circuit device 220 may be disposed on the protection circuit board 210. The protection circuit device 220 protects the battery pack 10, by monitoring the charge/discharge state of the bare cell 100, and the current, voltage, and temperature of the battery pack 10.

The IC chip 230 may be disposed on the bottom surface of the protection circuit board 210, and may be electrically connected to the loop antenna 300, via the loop antenna terminal 270. The IC chip 230 may perform RF communication with an external electronic apparatus (e.g., a RF signal reader), using the loop antenna 300.

The charge-discharge terminal 240 may be disposed on the top surface of the protection circuit board 210. The charge-discharge terminal 240 may serve as an electrical connector to supply power to an external electronic apparatus (not shown).

The positive electrode lead plate 250 may be disposed between the bare cell 100 and the protection circuit board 210, to electrically connect the cap plate 121 and the protection circuit board 210. Two positive electrode lead plates 250 may be disposed on opposing sides of the protection circuit board 210. The positive electrode lead plates 250 electrically connect the cap plate 121 to the protection circuit board 210. In some aspects, one of the positive electrode lead plates 250 may also electrically connect the cap plate 121 to the protection circuit board 210. The positive electrode lead plates 250 may be made of nickel or an alloy thereof, for example.

The negative electrode lead plate 260 may cover a welding through-hole 210a formed in a center portion of the protection circuit board 210. The negative electrode lead plate 260 may be electrically connected to the electrode terminal 122, by welding. The negative electrode lead plate 260 may be made of nickel or an alloy thereof, for example.

The loop antenna terminal 270 may be disposed on the bottom surface of the protection circuit board 210. The loop antenna terminal 270 may be electrically connected to a connection terminal 330 of the loop antenna 300.

The loop antenna 300 is shown as being disposed on the large lateral surface 103, but may be disposed on either of the large lateral surfaces 103 and 104. The loop antenna 300 may have a shape (e.g., a rectangular shape) corresponding to the large lateral surface 103. The loop antenna 300 includes an antenna pattern 310, a coverlay 320, and the connection terminal 330.

The antenna pattern 310 may be disposed in the coverlay 320, and may be coiled several times along edges of the coverlay 320. The antenna pattern 310 may be made of copper, for example. The coverlay 320 may be a thin film that covers the antenna pattern 310 and may be made of a polymer resin, e.g., polyimide. The connection terminal 330 may be connected to both ends of the antenna pattern 310, so as to be electrically connected to the loop antenna terminal 270.

The loop antenna 300 receives a RF signal from an external electronic apparatus (e.g., a reader) and transmits the RF signal to the IC chip 230. The IC chip 230 may then transmit a response RF signal to the external electronic apparatus, via the loop antenna 300. The RF transmission power of the loop antenna 300 may be an electromotive force induced by the RF signal from the external electronic apparatus. The loop antenna 300 may transmit and/or receive a 13.56 MHz RF, for example.

The absorber 500 may be a rectangular plate disposed between the bare cell 100 and the loop antenna 300. The absorber 500 can reduce a vortex signal generated by the loop antenna 300 and can increase the density of magnetic flux passing through the loop antenna 300, thereby improving RF sensitivity.

The absorber 500 may be formed of a ferrite sintered body. In more detail, the absorber 500 may be formed of a sintered body obtained by fully sintering one selected from nickel ferrite, zinc ferrite, nickel-zinc ferrite, and barium ferrite.

When the absorber 500 is formed of a nickel-zinc ferrite sintered body, the nickel-zinc ferrite may include from about 47 to 48 wt % of iron oxide, about 30 wt % of nickel oxide, about 20 wt % of zinc oxide, and from about 2 to 3 wt % of copper oxide, based on the total weight of the ferrite. FIGS. 3 and 4 are respectively 500× and 2000× SEM images of an absorber obtained by sintering a ferrite powder composed of 48 wt % of iron oxide, 30 wt % of nickel oxide, 20 wt % of zinc oxide, and 2 wt % of copper oxide.

A conventional absorber used in a battery pack or a mobile communication terminal is made of a composite of a ferrite powder and a rubber. However, because such an absorber includes rubber, the associated material costs and manufacturing processes are increased, as compared with an absorber according to aspects of the present invention.

That is, the absorber 500 may be manufactured by a simple process of mixing a ferrite powder and a binder, sintering, and removing the binder, which results in reduced manufacturing costs due to the omission of rubber. Moreover, the absorber 500 exhibits a higher magnetic permeability relative to a conventional absorber. Therefore, the absorber 500 has increased RF sensitivity, thereby improving a RF signal recognition distance between the loop antenna 300 and a reader.

The absorber 500 may have a thickness of about 1 mm, or less, for example, a thickness of from about 0.05 to 0.3 mm. If the thickness of the absorber 500 is less than about 0.05 mm, the absorber 500 may be easily fractured. On the other hand, if the thickness of the absorber 500 exceeds about 1 mm, the thickness of the battery pack 10 may be unnecessarily increased, thereby decreasing the capacity density of the battery pack 10, with respect to the capacity of the bare cell 100. A polymer layer may be further disposed on the surface of the absorber 500, in order to increase the durability of the ferrite sintered body. The absorber 500 may be attached to the bare cell 100 by a double-sided tape or a liquid adhesive.

The absorber 500 may cover between about 50% and 100% of the large lateral surface 103. If the absorber 500 covers less than about 50% of the large lateral surface 103, the RF sensitivity of the loop antenna 300 may not be significantly enhanced. On the other hand, if the absorber 500 larger than the large lateral surface 103, the capacity density of the battery pack 10, with respect to the capacity of the bare cell 100, may be decreased.

The absorber 500 may have magnetic permeability of from about 100 to 115 T. Taking into consideration that a mobile terminal uses a small-sized battery, and the absorber 500 has a thickness of less than about 1 mm, the magnetic permeability of the absorber 500 is significantly improved, as compared with a conventional absorber.

The upper case 910 and the lower case 920 cover the protection circuit module 200 and the bottom surface of the bare cell 100, respectively. The label 930 surrounds the large lateral surfaces 103 and 104 and the small lateral surfaces 105 and 106 of the bare cell 100. The upper case 910, the lower case 920, and the label 930 protect the bare cell 100, the protection circuit module 200, the absorber 500, and the loop antenna 300 from external impacts. The label 930 may be replaced with a hard plastic case. In this case, the absorber 500 and the loop antenna 300 may be formed on an inner surface of the case and coupled to the bare cell 100.

As described above, the battery pack 10 includes the absorber 500 formed of a ferrite sintered body. Therefore, the magnetic permeability thereof is increased, enhancing the RF sensitivity of the loop antenna 300, and resulting in improved communication between an external electronic apparatus and a mobile terminal including the battery pack 10.

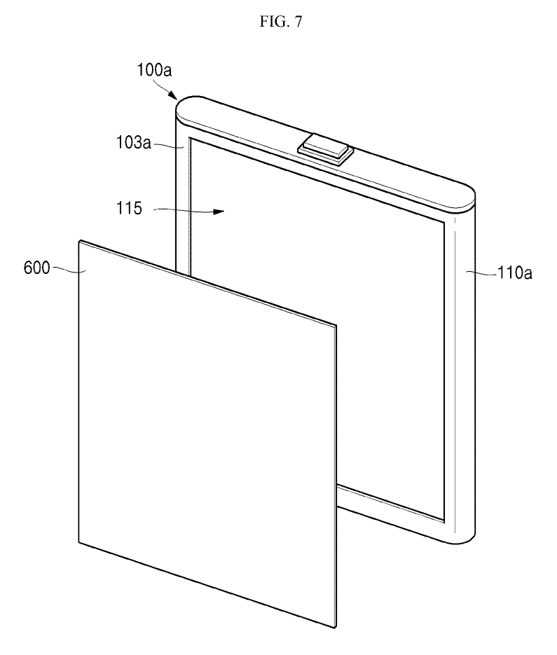

FIG. 7 is an exploded perspective view of a battery pack, according to another exemplary embodiment of the present invention. Referring to FIG. 7, the battery pack includes a bare cell 100a and an absorber 600.

A groove 115 is formed in a large lateral surface 103a of a can 110a of the bare cell 100a. The groove 115 is configured to accommodate the absorber 600. The absorber 600 may be secured in the groove 115 by a double-sided tape or an adhesive. Since the absorber 600 is received in the groove 115, the overall volume of the battery pack may be reduced, while maintaining the capacity of the bare cell 100a, thereby leading to an increased capacity density of the battery pack.

The battery pack is substantially the same as the battery pack 10, except for the shape of the bare cell 100a, i.e., except for the bare cell 100a including the groove 115. Therefore, a description of similar elements is omitted.

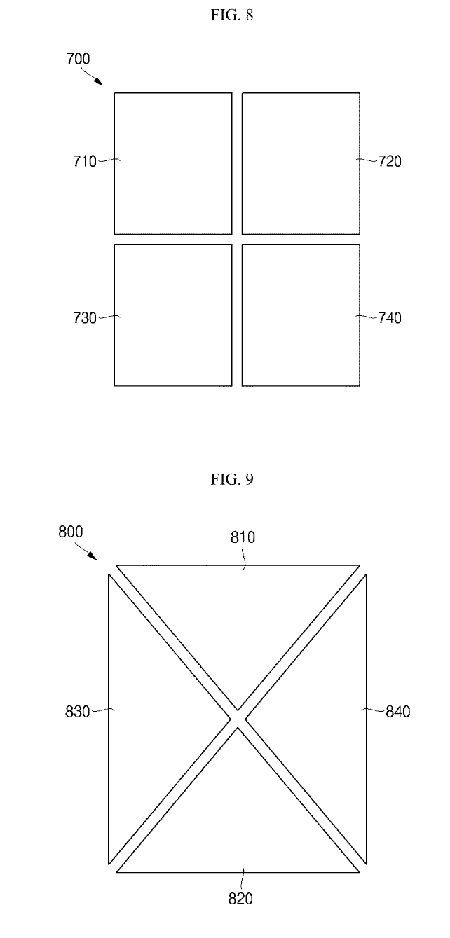

FIGS. 8 and 9 are plan views of absorbers 700, 800, according to other exemplary embodiments of the present invention. The absorbers 700, 800 can be applied to any of the previously described battery packs. Referring to FIGS. 8 and 9, the absorbers 700, 800 include ferrite sintered bodies that are divided into individual sections. In more detail, the absorber 700 includes four square-shaped sections 710, 720, 730, and 740, which are arranged such that the absorber 700 corresponds to a large lateral surface of a bare cell. The absorber 800 includes four triangle-shaped sections 810, 820, 830, and 840, which are arranged such that the absorber 800 corresponds to a large lateral surface of a bare cell.

During charging/discharging of a bare cell gas may be generated in a can, which causes the can to swell. Generally, when swelling occurs an electrode assembly is volumetrically increased, and thus, central portions of the large lateral surfaces of a bare cell protrude outward. Such swelling may break a single sheet-type absorber into a plurality of irregular sections. On the other hand, because the absorbers 700, 800 are formed of ferrite sintered bodies including a plurality of sections, such breakage does not occur.

That is, according to various embodiments, an absorber may include a ferrite sintered body that is divided into sections, which are separated by gaps that extend from a central portion of a large lateral surface of a bare cell. Therefore, even when swelling occurs in the bare cell, it is possible to prevent the absorber from being cracked or broken.

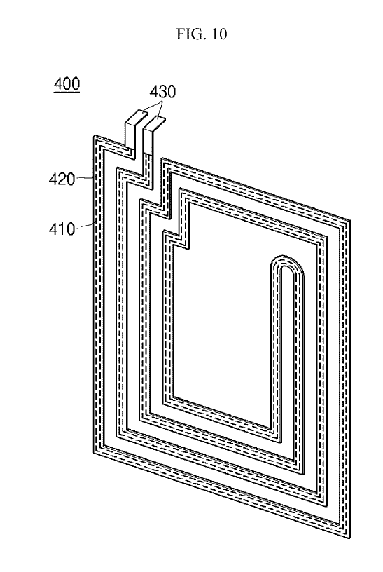

FIG. 10 is a perspective view of a loop antenna 400, according to another exemplary embodiment of the present invention. Referring to FIG. 10, the loop antenna 400 may include an antenna pattern 410, an insulator 420, and a connection terminal 430. The loop antenna 400 may be used in place of the loop antenna 300.

The antenna pattern 410 may be coiled several times into a loop that extends along edges a large lateral surface of a bare cell. The antenna pattern 410 may be made of copper. The insulator 420 may surround the antenna pattern 410. Thus, the insulator 420 has the same pattern as the antenna pattern 410. The connection terminal 430 may be connected to both ends of the antenna pattern 410, and may be electrically connected to a loop antenna terminal (not shown) disposed on a bottom surface of a protection circuit board (not shown).

The loop antenna 400 has similar RF sensitivity to that of the loop antenna 300 shown in FIGS. 1 through 6, but is more cost-effective due to the use of the insulator 420. Therefore, it is possible to reduce the manufacturing costs of a battery pack including the loop antenna 400.

Battery packs according to various exemplary embodiments of the present invention include an absorber formed of a ferrite sintered body, thereby enhancing the RF sensitivity of a loop antenna. Thus, communication between an external electronic apparatus and a mobile terminal including the inventive battery pack is improved, and the capacity density of the battery pack is increased, while reducing battery manufacturing costs.

As is apparent from the above description, provided is a battery pack that includes an absorber formed of a ferrite sintered body. The absorber has increased magnetic permeability, and thus, enhances the RF sensitivity of a loop antenna.

Moreover, the absorber does not include rubber, thus simplifying a battery pack manufacturing process and reducing manufacturing costs. In addition, it is possible to reduce the volume of a battery pack, while maintaining the capacity of a bare cell, thereby increasing the capacity density of the battery pack.

Although a few exemplary embodiments of the present invention have been shown and described, it would be appreciated by those skilled in the art that changes may be made in these exemplary embodiments, without departing from the principles and spirit of the invention, the scope of which is defined in the claims and their equivalents.

What is claimed is:

1. A battery pack comprising:
a bare cell having opposing first and second surfaces, and opposing third and fourth surfaces that are smaller than the first and second surfaces; and
an absorber disposed on the first surface of the bare cell, comprising a ferrite sintered body.

2. The battery pack of claim 1, wherein the ferrite is selected from the group consisting of nickel ferrite, zinc ferrite, nickel-zinc ferrite, and barium ferrite.

3. The battery pack of claim 1, wherein the ferrite is a nickel-zinc ferrite comprising from about 47 to 48 wt % of iron oxide, about 30 wt % of nickel oxide, about 20 wt % of zinc oxide, and from about 2 to 3 wt % of copper oxide, based on the total weight of the nickel-zinc ferrite.

4. The battery pack of claim 1, wherein the absorber has a thickness of about 1 mm, or less.

5. The battery pack of claim 4, wherein the absorber has a thickness of from about 0.05 to about 0.3 mm.

6. The battery pack of claim 1, wherein the absorber covers between about 50% and about 100% of the first surface of the bare cell.

7. The battery pack of claim 1, further comprising a polymer layer disposed on the surface of the absorber.

8. The battery pack of claim 1, further comprising a double-sided tape to attach the bare cell to the absorber.

9. The battery pack of claim 1, further comprising an adhesive to attach the bare cell to the absorber.

10. The battery pack of claim 1, wherein the absorber is disposed in a groove corresponding to the shape of the absorber, formed in the first surface of the bare cell.

11. The battery pack of claim 1, wherein the ferrite sintered body comprises a plurality of separate sections.

12. The battery pack of claim 11, wherein the sections are triangular or rectangular.

13. The battery pack of claim 1, further comprising a loop antenna disposed on the absorber.

14. The battery pack of claim 13, further comprising a protection circuit module that is electrically connected to the loop antenna.

15. The battery pack of claim 13, wherein the loop antenna transmits/receives a 13.56 MHz radio frequency (RF) signal.

16. The battery pack of claim 13, wherein the loop antenna comprises:
a loop-shaped antenna pattern; and
a coverlay film covering the antenna pattern.

17. The battery pack of claim 13, wherein the loop antenna comprises:
a loop-shaped antenna pattern; and
an insulator surrounding the antenna pattern.

18. The battery pack of claim 16, wherein the antenna pattern is made of copper.

19. A mobile communication terminal comprising the battery pack of claim 1.

20. The battery pack of claim 1, wherein the absorber has magnetic permeability of from about 100 to about 115 T.

21. The battery pack of claim 11, wherein the sections are separated by channels that extend across the center of the first surface.
